(19) United States
(12) Patent Application Publication
(10) Pub. No.: US 2004/0131094 A1
(43) Pub. Date: Jul. 8, 2004

(54) Method of controlling the extinction ratio of a laser

(76) Inventor: Reza Miremadi, West Hills, CA (US)

Correspondence Address: BARLOW, JOSEPHS & HOLMES, LTD., 101 DYER STREET, 5TH FLOOR, PROVIDENCE, RI, 02903, US

(21) Appl. No.: 10/738,807

(22) Filed: Dec. 17, 2003

Related U.S. Application Data
(60) Provisional application No. 60/435,571, filed on Dec. 18, 2002.

(51) Int. Cl. H01S 3/13

(52) U.S. Cl. 372/29.02

(57) ABSTRACT

The present invention utilizes two monitoring and feedback loops to track the performance of the laser output as it relates both to the environmental conditions and the effects that gradual changes in the efficiency slope of the laser performance curve have on the modulation amplitude of the laser. The first control loop operates to monitor the changes in the average power output of the laser resulting from the impact of environmental factors and to apply an adjustment thereby increasing or decreasing the drive current to maintain the average power output of the laser at a constant state. The second control loop operates periodically to determine the slope of the performance curve to determine the operating efficiency of the laser thereby providing feedback necessary to determine the drive current necessary to modulate the laser at a constant extinction ratio.

### CROSS-REFERENCE TO RELATED APPLICATIONS

This application is related to and claims priority from earlier filed provisional patent application No. 60/435,571, filed Dec. 18, 2002.

### BACKGROUND OF THE INVENTION

The instant invention relates generally to method of controlling the output of a laser diode to maintain a constant extinction ratio, defined as the difference in the amplitude of the laser modulation between high and low pulses. More specifically, the present invention relates to a method of controlling a laser diode using a first control loop to adjust the laser output based on environmental factors and age of the laser diode, and a second control loop that serves to monitor modulation output of the laser to automatically control and maintain an optimal and constant extinction ratio.

In the prior art, a number of control circuits in various configurations have been used for maintaining a constant output level from a laser diode. As is well known in the art, the performance and attendant output from a laser diode is related to several factors. However, there are two main factors that must be considered in controlling the laser output power relative to the driving current. First, the initial operating point of the laser must be controlled to maintain the laser in the proper operating range. Referring to FIG. 1, the optical output power of the laser diode (represented along the Y-axis) can be seen in the representative curve as being a non-linear function of the laser diode drive current. In particular, when forward bias drive current (represented along the X-axis of the graph) is applied to a semiconductor laser it begins to emit light in a manner similar to light emitting diodes (LEDs). This type of emission is known as spontaneous emission because it happens randomly from excited atoms in the laser diode cavity, and is commonly called LED mode. At a certain drive current, the laser diode efficiency for converting current into light increases dramatically. This is the point where the laser diode transitions from the LED mode of operation to the lasing mode of operation.

While various classes of laser diodes will have thresholds in the same general range of drive currents, the transition point from LED mode to lasing mode varies considerably among laser diodes of the same type and also varies as a result of environmental factors (temperature) and/or the age of the laser diode. As can be seen in FIG. 1 for example, a graphic representation of the laser diode output is shown relative to the laser drive current input for operations at two different operational temperatures. As can easily be seen, the transition point from LED mode to lasing mode is dramatically different for the same laser operating at 25° C. and at 75° C. The effect of this temperature sensitivity is that at a fixed drive current the laser diode could be operating above its recommended output level at one temperature while not even lasing at another higher temperature.

Additionally, as can be seen in FIG. 1, when the laser diode is operating in the lasing mode, i.e. operating at a drive current beyond the transition point on the graph, the curve has a determinable slope that characterizes the laser diode efficiency. More specifically, the efficiency of each laser diode is equal to the ratio between the changes in the optical output power of the laser relative to changes in the drive current while operating in the lasing mode. The characteristic slope of this line varies from laser diode to laser diode, and also varies with temperature and with the age of the laser. It is therefore important that the initial operating point, or initial bias current, of the laser is set by the user so that it is within a defined range that remains within the lasing mode of operation throughout various environment conditions and so that the laser diode remains in lasing mode as the drive current is modulated when applying an input signal to the laser. In other words, the operation point must be set sufficiently high so that the low end of the modulation does not cause the laser diode to transition out of the lasing mode while not setting the operation point so high as to prematurely burn out the laser diode at the high end of the modulation. For example, while the initial bias set point i′ places the operation of the laser well within the lasing range for operation at 25° C., it can be seen that at an operational curve representing 75° C. a set point i′ places the laser into the LED operating range. For operation at 75° C., the bias set point must be moved to i″ to bring the laser into lasing mode.

Due to the changes in the performance of the laser that result from environmental factors, a means for controlling the laser output in response to changing environmental variables is necessary. One method of controlling the output of a laser diode is to incorporate a thermoelectric cooler into a laser package so as to keep the diode at a constant temperature. In this regard, temperature remains constant and the bias can remain constant. The disadvantage of such solutions is that thermoelectric cooler designs tend to increase the manufacturing costs and to decrease the reliability of the laser diode since any failure in the thermoelectric cooler device or its circuitry will result in the applied bias current being inappropriate as the temperature of the laser diode varies. Similarly, other control circuits have also been proposed whereby the output power of the laser is monitored successively over time and the original bias setting itself is incrementally increased or decreased relative to the original set point.

The difficulty is that in this single loop control system, while the control loop is capable of monitoring the average output performance of the laser, this loop does not measure or account for the second factor relating to the lasers performance, namely that the efficiency of the laser (slope of the curve) also varies in relation to changes in temperature and over the life cycle of the laser. As a result, while the average output is adjusted to a known range using the single loop control, the extinction ratio of the laser, is also affected resulting from the changes in the slope of the curve. Referring again to FIG. 1, it can be seen that when a fixed modulation current 1 is applied at bias setting point i′ the laser produces an output modulation 4 having a certain amplitude. As the operational environment moves from 25° C. to 75° C. and the bias point is moved from i′ to i″, while the average output of the laser remains constant, the same modulation current 2 produces a different output modulation 3 and a resultant change in the extinction ratio of the laser. Therefore in a system where the average bias point is adjusted using a single control loop, if the slope of the curve is flatter and a fixed modulation current is used, the amplitude of the output modulation will be flatter. Similarly, if the curve becomes steeper and the modulation current is maintained static, then the output amplitude modulation is relatively greater.

Other solutions in the prior art utilize a dual loop controller that in addition to adjusting the bias set point to maintain the base operational point of the laser relative to environmental changes, also utilize a periodic low frequency modulation tone that produces a laser output pulse that is read by a feedback diode. The amplitude of the modulation is determined and the modulation current is adjusted to accommodate for the change in the extinction ratio thereby producing constant amplitude for outputs 3 and 4. The drawback to this control scheme is that when the operational temperatures increase and the drive currents become higher, the feedback being provided by the control loops becomes a smaller value. This is problematic because the smaller feedback values result in greater potential for error whereby a laser being driven at higher drive currents may be overdriven or even burned out.

Yet a further limitation in prior art laser diode controllers is that they cannot be used to predict device failures in advance of the actual failure. Since the particular application for the present invention is in the field of vital communications systems, when such lasers fail they can cause entire communications systems to fail. If the failure of a laser could be accurately predicted, a preventative maintenance program could be implemented to prevent system failures by replacing the lasers prior to the time that failure is predicted. Currently, such lasers are replaced solely based on their time in service without regard to their actual operability.

There is therefore a perceived need for a laser control system that includes an automatic power control loop and that is also capable of maintaining a constant extinction ratio while reducing the potential for overdriving the laser at critical high temperature operational points.

### BRIEF SUMMARY OF THE INVENTION

In this regard, the present invention provides for a novel method of controlling a laser diode utilizing two control loops. The first loop is an automatic power control (APC) loop which adjusts the initial bias responsive to temperature and/or age, while the second loop is responsible for monitoring and maintaining a constant modulation amplitude or extinction ratio. In contrast with the prior art method, the secondary control loop of the present invention provides an increasing feedback value as operational temperatures increase.

In the present invention, when the laser module is manufactured, the initial bias set point is manually determined and set. Subsequently, the method of the present invention utilizes an automatic power control loop to adjust the bias responsive to changes in environmental conditions and/or responsive to aging of the laser. A second control loop is then used to periodically calculate the slope of the laser and control the modulation amplitude of the laser responsive to changes in the slope. The APC loop operates as is well known in the art to monitor the changes in the average power output of the laser resulting from the impact of environmental factors. As the environment in which the laser is operating changes, the average output of the laser changes and the APC loop detects the change. Once the change in average power is detected, a corresponding increase in drive current is determined and applied to modify the initial bias point thereby increasing or decreasing the drive current to maintain the average power output of the laser at a constant state.

The second control loop is utilized as an additional overlay to the APC loop. The second control loop operates periodically to determine the slope of the performance curve to determine the operating efficiency of the laser thereby providing feedback necessary to determine the drive current necessary to modulate the laser at a constant extinction ratio. Further, as the secondary loop calculates the efficiency, the value is recorded and stored. In this manner the performance record of the laser can be compared to a standard set of data points to estimate the failure point of the laser and notify the operator that replacement is required in advance of actual failure.

Accordingly, one of the objects of the present invention is the provision of a method of controlling a laser diode to maintain a constant operational state and a constant extinction ratio. Another object of the present invention is to provide a method of controlling a laser diode including a control loop that produces successively larger feedback signals at higher drive current levels. Yet another object of the present invention is the provision of a method for controlling the operation of a laser diode in a passive manner that does not require user intervention during operation of the device. A further object of the present invention is the provision of a method of controlling a laser diode wherein the control loop records the changes in the efficiency of the laser output to predict device failure in advance of actual failure.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is graphic representation of prior art operational characteristics and monitoring methods for a laser diode;

FIG. 2 is graphic representation of operational characteristics and monitoring methods for a laser diode illustrating the method of the present invention; and

FIG. 3 is schematic diagram illustrating the general components utilized in the dual loop control method of the present invention.

### DETAILED DESCRIPTION OF THE INVENTION

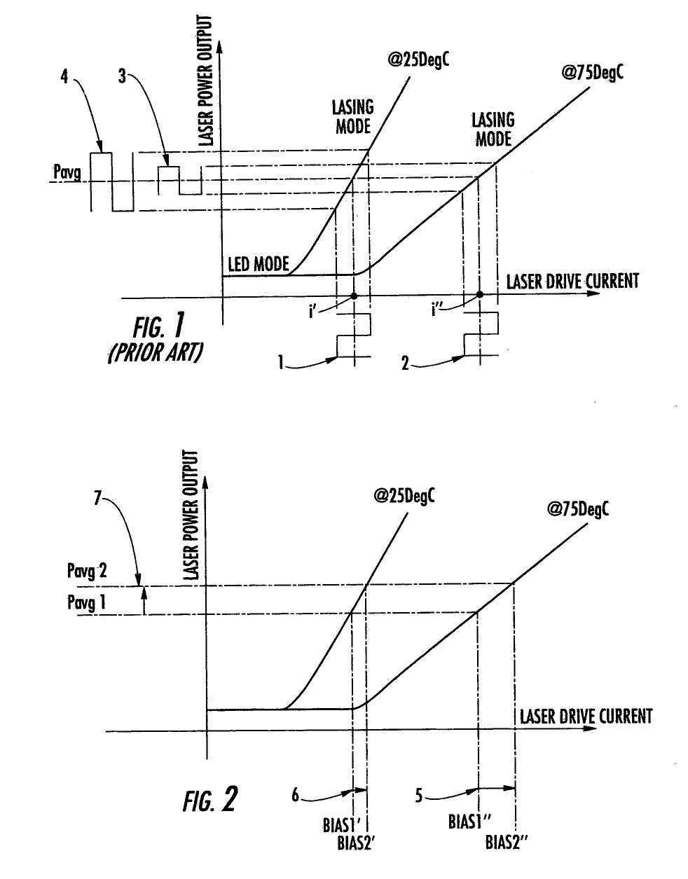

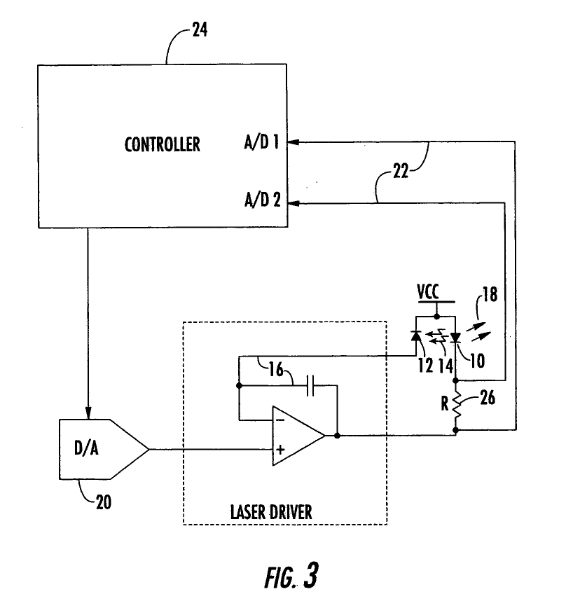

Referring now to the drawings, the method of controlling a laser diode is generally illustrated in the graph provided in FIG. 2 while the general schematic structure of the dual loop control system of the present invention is illustrated in FIG. 3. Referring to FIG. 3, there is shown a laser diode 10 and monitoring photodiode 12. The laser diode 10 and monitoring diode 12 are arranged in such a manner wherein energy emitted from the back facet 14 of the laser diode 10 is directed onto the monitoring diode 12. Circuitry is provided to direct the signal generated by the monitoring diode 12 as a result of stimulation by energy from the back facet 14 of the laser diode 10 back into the automatic power control (APC) loop 16 of the present invention thereby providing the feedback necessary for the APC loop 16 to either increase or decrease the drive bias of the laser diode 10 to meet the power output requirements. Energy emitted from the front face 18 of the laser diode 10 is directed as the output energy of the laser diode 10 and is utilized for its designated purpose which is not within the scope of this disclosure.

The first control loop is an analog APC loop 16 that serves to maintain the laser diode 10 at a constant average power output. The second control loop operates periodically to determine the operational efficiency of the laser diode 10 as represented by the slope of the line (as a function of the relationship between drive current and power output of the laser 10) and calculates the correct modulation of drive current required to maintain the laser 10 at a constant state extinction ratio during modulation of the laser 10.

The method and apparatus of the present invention utilizes a layered arrangement of laser drive current (bias) adjustments to provide laser output that remains at a constant average output level in addition to maintaining a constant extinction ratio for modulation of the laser diode 10. The initial step in configuring the laser module of the present invention is manually setting the initial bias for the base line drive current of the laser diode 10. In this step the device is attached to an oscilloscope and power is applied to the laser 10. The laser output is monitored using the oscilloscope and the initial bias is adjusted incrementally until the laser reaches the desired power output for the given environmental conditions. The bias setting is normally done using a digital pot or digital analog converter (D/A) 20 as is well known in the art. Once this setting is determined and the initial bias is set, the baseline bias is not changed again during the normal operating life of the laser device.

Once the initial bias for the device is set, the APC loop 16 monitors the feedback form the monitoring diode 12 to determine the laser diode 10 power output. Using this feedback, the APC loop 16 applies an overlay adjustment to the initial bias to adjust the drive current of the laser 10 thereby maintaining the required average power output at a constant operational level. The APC loop 16 is an analog loop that compares the input signal from the monitor diode 12 and makes an adjustment to the drive current upwardly if the average output of the laser 10 falls below a preset level or downwardly if the average output increases. The change applied by the APC loop 16 is generally quite small as the operational environment in which the laser devices are operated is controlled. However, since the operation of laser diodes 10 is highly effected by the ambient temperature of the surrounding environment, this APC loop 16 provides important feedback for controlling the laser 10 and maintaining its operation at a constant level average power output.

The second control loop 22 is provided to maintain the operation of the laser diode 10 at a constant extinction ratio. In this manner, the second control loop 22 provides an important function in that by maintaining a constant extinction ratio, the quality and integrity of signal that is superimposed onto the modulation of the device can be maintained. As was described above, in addition to a shift in the position of the laser diode 10 performance curve that results from changes in environmental conditions and diode age, the slope of the curve also typically decreases as the ambient temperature increases and the diode ages. As can be seen in FIG. 1 this results in a requirement for higher drive currents, evidenced in the shift required from i′ to i″, in order to maintain the same output levels given the same laser diode 10. It can also be seen that in the control schemes of the prior art, as the drive current increases, the modulation current must also be increased in order to maintain the same modulation amplitude or extinction ratio. This is clearly illustrated by the differences seen between the modulation of pattern 3 versus the modulation of pattern 4. It is also clear that as the slope of this curve falls, larger incremental increases in current cause much smaller increases in the laser power output. This results in increasingly larger drive currents being applied to the laser diode 10 with smaller and smaller incremental changes in the laser output power P_{avg}, and therefore increasingly smaller feedback values for system evaluation and control.

Turning to FIG. 2 in conjunction with the schematic diagram in FIG. 3, the operation of the second control loop 22 of the present invention is graphically illustrated. Periodically, the controller device 24 in the laser assembly executes a test loop to evaluate the extinction ratio of the laser diode 10. When the test loop is executed, it determines the current operating state of the laser diode 10. Since the laser 10 is running at a constant output level, the initial power output is known. This output power corresponds to P_{avg1} as maintained by the APC loop 16. With the laser diode 10 operating at this state the controller 24 reads the values of A/D1 and A/D2. By subtracting A/D1 from A/D2 and dividing by the value R of the in line resistor 26, the controller 24 can calculate Bias1.

Bias1=(A/D2−A/D1)/R

The controller 24 then adjusts the average power output target requirement for the laser diode 10 from P_{avg1} to P_{avg2} by changing the setting of the D/A or digital pot 20. Once the output requirement for the laser 10 is increased, the APC loop 16 then begins to apply additional drive current until the laser output 10 reaches the new P_{avg2} target output level that corresponds to the new output requirement. With the laser diode 10 operating at this new state, the controller 24 again reads the new values of A/D1 and A/D2 that correspond to operating the laser diode 10 at an output of P_{avg2}. By subtracting the new values if A/D1 from A/D2 and dividing by the value R of the in line resistor 26, the controller 24 can calculate Bias2.

Bias2=(A/D2−A/D1)/R

As can be clearly seen in FIG. 2, the starting point for the second control loop 22 corresponds to the desired constant state output level of the laser diode 10 or P_{avg1}. The corresponding drive current is illustrated as Bias1′. This drive current, Bias 1′, corresponds to the initial manually set bias of the device as modified by the incremental overlay provided by the APC loop 16. Similarly, the second current level, Bias2′, is the required drive current to drive the laser diode at the incrementally higher output requirement of P_{avg2}. Once the controller completes the above operation to determine all of the required variables, namely the drive current P_{avg2}, Bias 1′ and Bias2′, the algorithm uses the change from Bias1′ to Bias2′ (6) and determines the operational efficiency of the laser diode 10 by solving the following linear algebraic calculation for the slope (m):

$$m = \frac{{P}_{avg2} - {P}_{avg1}}{{Bias2}^{′} - Bias {1}^{′}}$$

This value provides the characteristic operating efficiency of the laser diode 10 at that given point in time in the current environmental conditions. This number can then be utilized to determine the incremental value by which the drive current must be modulated to produce the predetermined required modulation in the laser diode 10 output to maintain a constant extinction ratio. In this manner the second control loop 22 periodically recalibrates itself using the present operational properties of the laser diode 10 to maintain a constant laser modulation having a constant extinction ratio.

It can also be seen in FIG. 2 that the present operational temperature and the corresponding APC 16 overlay set point for the initial bias of the laser 10 does not effect the operation of the second control loop 22. As can be seen, while the operational temperature of the device increases from 25° C. to 75° C. the operational curve shifts to the right and the efficiency slope begins to fall. However, the APC loop 16 has provided an adjustment overlay that is applied to the initial bias to shift the operational bias from bias1′ to bias1″. This adjustment overlay applied by the APC loop 16 serves to maintain the operational base line of the laser 10 at the required average power output of P_{avg1}. Consequently, when the second control loop 22 begins its test mode, the baseline output requirement is still P_{avg1} and the incremental change is still made by adjusting the output requirement to P_{avg2}. Therefore, the slope of the line is simply calculated utilizing the new drive currents, bias1″ and bias2″ as modified by the APC loop 16.

It should be noted that the application of testing values in the present invention is reversed from the traditional testing methods. More specifically, the prior art methods applied increasing current and monitored the laser output until a constant output level was reached. In these prior art methods, the test used for the second control loop was the actual modulation of the laser itself. In contrast, the method of the present invention sets a higher output drive requirement and monitors the input of current until the newly set target laser output level is reached. The present method therefore only requires adjustments in the drive current relative to a small incremental change in the output requirement before applying a large modification to the drive current as required to maintain the laser 10 at a constant operational extinction ratio thereby reducing the possibility of overdriving the laser 10.

A further advantage that is seen in the present invention is illustrated clearly in FIG. 2. In particular, the magnitude of the feedback values provided to the controller 24 can be seen to increase as the operational temperature of the device increases. This is evidenced by the spatial relationship illustrated between bias1′ and bias2′ (6) relative to the spacing seen between bias1″and bias2″ (5). Since operation of the laser diode 10 is extremely sensitive and slope of the operational curve is relatively steep in the lasing mode of operation it can be appreciated that higher feedback values are increasingly valuable at the higher operational ranges. It can also be seen that as higher operational levels are reached in the prior art, the amount of feedback generated decreases providing decreased operational tolerance at critical operational levels. Therefore, the present invention provides a feedback signal that increases at higher temperatures where the feedback is most useful.

It is therefore a combination of the three biasing factors, the manually set initial bias, the APC loop 16 bias overlay and the slope of the operational curve of the laser 10 as determined by the second control loop 22 that are all factored together to control the operation of the laser 10. The APC loop 16 bias overlay in conjunction with the manually set bias at the D/A 20 serves to maintain the laser 10 at a constant average operational power while the slope provided by the second control loop 22 is utilized to determine the required current modulation to create a constant extinction ratio during operation of the laser diode 10.

It can therefore be seen that the present invention provides a novel method for operating and controlling a laser diode 10. In particular, the present invention provides a novel dual-loop control method for controlling a laser diode 10 that is capable of determining the efficiency and operating characteristics of the diode without unduly stressing the laser 10. Further, the present invention provides a novel dual-loop control system that is reliable and provides incrementally higher feedback values at more critical laser operational levels while also being inexpensive to manufacture and implement. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of periodically testing the efficiency of a laser diode and maintaining a constant modulation output for said laser diode comprising the steps of:
selecting a first laser power output level;
applying a first bias to a laser diode, said first bias energizing said laser diode and causing said laser diode to generate output at said first output level;
measuring and recording said first bias;
selecting a second laser power output level;
applying a second bias to said laser diode, said second bias energizing said laser diode and causing said laser diode to generate output at said second output level;
measuring and recording said second bias;
calculating the efficiency of said laser diode using said first and second output levels and said first and second biases; and
using said efficiency calculate a bias modulation value, wherein application of said bias modulation value to said laser causes said laser to modulate at a constant amplitude.

2. The method of claim 1, further comprising:
recording said periodically calculated efficiency of said laser diode and comparing said efficiency to a known value to predict the failure point of said laser diode in advance of actual failure of said laser diode.

3. The method of claim 1, said step of calculating the efficiency of said laser diode further comprising:
calculating the efficiency of said laser diode using the formula
$$efficiency = \frac{second output level - first output level}{second bias - first bias}$$

4. A method of controlling and periodically testing the efficiency of a laser diode and maintaining a constant modulation output for said laser diode comprising the steps of:
selecting a first laser power output level;
setting a first bias corresponding to said first laser power output level;
applying a first bias to a laser diode, said first bias energizing said laser diode and causing said laser diode to generate output at said first output level;
utilizing a first control loop to automatically control the power output level of said laser diode,
said first control loop monitoring the laser power output level of said laser diode to determine changes in said power output level, and
applying a bias adjustment factor that corresponds to the changes in said power output level to said first bias to maintain said laser diode at said first power output level; and
utilizing a second control loop to periodically calculate the efficiency of said laser diode and to calculate the required current modulation values,
said second control loop periodically measuring and recording the sum of said first bias and said bias adjustment factor,
selecting a second laser power output level,
applying a second bias to said laser diode, said second bias energizing said laser diode and causing said laser diode to generate output at said second output level,
measuring and recording said second bias,
calculating the efficiency of said laser diode using said first and second output levels and said first and second biases, and
using said efficiency calculate a bias modulation value, wherein application of said bias modulation value to said laser causes said laser to modulate at a constant amplitude.

5. The method of claim 4, further comprising:
recording said periodically calculated efficiency of said laser diode and comparing said efficiency to a known value to predict the failure point of said laser diode in advance of actual failure of said laser diode.

6. The method of claim 4, said step of calculating the efficiency of said laser diode further comprising:
calculating the efficiency of said laser diode using the formula
$$efficiency = \frac{second output level - first output level}{second bias - first bias}$$
